(19) United States
(12) Patent Application Publication
(10) Pub. No.: US 2011/0156435 A1
(43) Pub. Date: Jun. 30, 2011

(54) Driver's blind spot terminator

(76) Inventor: L. Thomas Carter, Wrightwood, CA (US)

(21) Appl. No.: 12/928,376

(22) Filed: Dec. 10, 2010

Related U.S. Application Data
(60) Provisional application No. 61/283,931, filed on Dec. 10, 2009.

(51) Int. Cl. B60J 3/06

(52) U.S. Cl. 296/97.6

(57) ABSTRACT

Driver's Blind Spot Terminator comprises a three-piece sun shield which is easily secured to an existing automobile sun visor and filters the sun's harmful ultraviolet rays, thus eliminating blind spots comprising interchangeable and fully adjustable sun shields which are secured to the vehicle sun visor by way of a flexible support arm. Each sun shield is a geometrically shaped unit manufactured of optical glass or shatterproof material. The first shield comprises a clear, polarized lens designed to filter the sun's harmful ultra violet rays. The second shield is tinted in any number of hues including blue, and other embodiments in gray and green respectfully. This shield is designed to provide shady comfort while also blocking the sun's rays. The third shield is an amber colored shield designed for use during foggy or snowy conditions.

### CLAIM OF PRIORITY

This patent application claims priority under 35 USC 119(e) (1) from U.S. Provisional Patent Application Ser. No. 61/283,931 filed Dec. 10, 2009, of common inventorship herewith entitled, “Driver's Blind Spot Terminator.”

### FIELD OF THE INVENTION

The present invention pertains to the field of automotive sun visors, and more specifically to the field of adjustable automotive sun visors.

### BACKGROUND OF THE INVENTION

The prior art has put forth several designs for adjustable automotive sun visors. Among these are:

U.S. Pat. No. 5,033,528 to Yanon Volcani describes a portable sunshade comprising a disc having a surface area sufficient for shading a particular portion of a user's body, which disc is supported at its edge by a flexible extension that is connected to a rigid extension that in turn is connected to a lamp or suitable supporting device.

U.S. Pat. No. 5,564,771 to Thomas P. Chesters describes an improved auxiliary shading device for use upon a vehicle sun visor, typically having a flexible shading endpiece of sufficient size to shade the focal light rays of the rising or setting sun or headlamp glare.

US Patent Application 20040217621 to Thomas Paul McCoy describes a sun visor with flexible arm for shielding sun, glare, vehicle headlights or other distractions from the eyes of the vehicle's operator. The compact sun visor's shield is attached to a flexible arm, allowing for limited visor positioning. The visor may be permanently mounted or affixed with various clips or adhesives to a motor vehicle, helmet or any object requiring shading, allowing for mounting wherever the operator desires.

None of these prior art references describe the present invention.

### SUMMARY OF THE INVENTION

It is an object of the present invention to provide a design improvement for adjustable automotive sun visors.

### BRIEF DESCRIPTION OF THE DRAWINGS

FIG. 1 is a front perspective view of the device of the present invention installed in a vehicle.

FIG. 2 is an elevational view of the interchangeable colored discs.

FIG. 3 shows an elevational view of the apparatus disassembled.

FIG. 4 shows an elevational view of a portion of the apparatus.

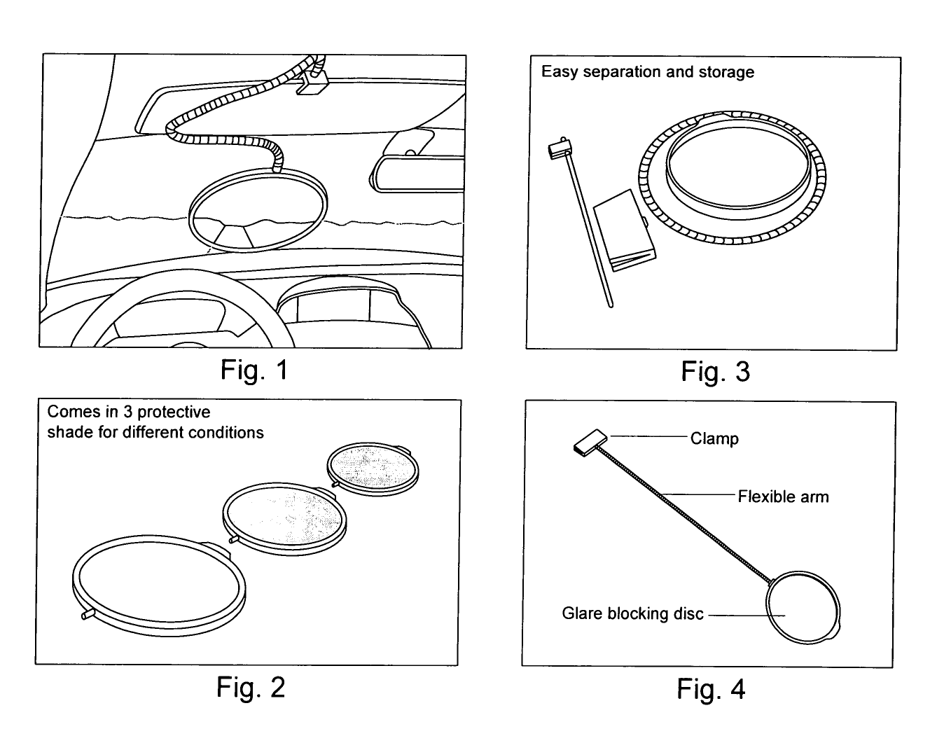

### DETAILED DESCRIPTION OF THE INVENTION

Everyday, millions of consumers climb into their automobiles and head off for a day of work, school, or recreation. Whether a busy executive traveling to an important business luncheon, a homemaker dropping the kids off at a school dance, or a professional delivery man making his rounds, automobiles offer consumers a simple and efficient means of traveling from one destination to the next. Most considerate drivers realize the importance of staying alert behind the wheel and because of this pay close attention to the comings and goings of traffic, their speed, road signs and stop lights.

Unfortunately, as many drivers attest, there are those obstacles that even the most conscientious of drivers cannot avoid. In particular, driving in the direction of sunlight is both difficult and dangerous. Causing unavoidable “blind spots,” the glare of intense sunlight makes it almost impossible to see the road ahead. Resulting in low-contrast vision, glare from the sun or even that which bounces off of other vehicles is distracting and directly effects driving comfort and safety. Burning the eyes and causing fatigue and strain, the blinding glare caused by ultraviolet rays makes even the shortest of journeys exhausting and stressful. Most consumers attempt to solve this problem by utilizing a sun visor. Sun visors are a standard feature in all cars and trucks and offer the driver a simple means of reducing glare and shading their eyes. Although sun visors are a practical accessory, they do little to combat the glare which enters the vehicle from the side door windows, as well as the area directly below the rear view mirror or the visor itself. While attempting to adjust the sun visor so it can block this glare, light enters the vehicle through the front of the windshield, again, leaving the driver susceptible to the aforementioned dangers.

The present invention, hereinafter referred as the Driver's Blind Spot Terminator, is a specially designed three-piece sun shield which is easily secured to an existing automobile sun visor and designed specifically to filter the sun's harmful ultraviolet rays, thus eliminating blind spots. The Driver's Blind Spot Terminator is comprised of three, interchangeable and fully adjustable sun shields which are secured to the vehicle sun visor by way of a flexible support arm, included for sale with the unit. Each Driver's Blind Spot Terminator sun shield is a geometrically shaped unit manufactured of optical glass or, in another embodiment, comparable shatterproof material. Geometric shapes suitable for use in the invention include, but are not limited to: circles, rectangles, ovals, pie shapes, triangles, wedges, or any other shapes, for example. These disc-like shields measure approximately six inches to twelve inches in diameter and feature a sturdy outer ring manufactured of lightweight metal or plastic material, providing structural support to the unit. As mentioned, three disc shields are included with the Driver's Blind Spot Terminator. The first shield boasts a clear, polarized lens designed to filter the sun's harmful ultra violet rays. The second shield is tinted in any number of hues including blue, and other embodiments in gray and green respectfully. This shield is designed to provide shady comfort while also blocking the sun's rays. The third shield included in the Driver's Blind Spot Terminator kit is an amber colored shield designed for use during foggy or snowy conditions. As mentioned, these sun shields are secured to the existing sun visor by way of a flexible accordion or in another embodiment, coiled support arm measuring approximately eighteen to twenty-four inches in total length, with the distal end of the arm featuring a sturdy, spring loaded clamp for use in securing the unit to the visor, while the opposite end boasts a threaded female fitting utilized in conjunction with a corresponding male fitting secured to each shield. As an added feature, included for sale with the Driver's Blind Spot Terminator, is a lightweight zippered carrying case which serves to keep the individual discs clean and lint and spot free between uses.

Use of the Driver's Blind Spot Terminator is very simple and straight forward. The consumer simply secures the Driver's Blind Spot Terminator extension arm to the base of their vehicle sun visor. Alternately, this side arm is mounted to a dashboard, or door handle. With the side arm installed, the Driver's Blind Spot Terminator interchangeable sun shield is employed as needed. For instance, the tinted shield is secured to the extension arm and the arm then positioned in front of the driver's side window in order to block bright sunlight entering from the side of the vehicle. In order to adjust the positioning of the attached shield the user needs only manipulate the flexible arm in order to raise, lower or move the shield from side to side. After use, the Driver's Blind Spot Terminator is removed and stored away in the handy carrying case until again needed.

The Driver's Blind Spot Terminator is a unique product invention which offers consumers many significant benefits and advantages. Foremost, this cleverly designed product invention provides those driving or riding in the front seat of automobiles, a comfortable means of viewing the road. Boasting three interchangeable discs which serve to reduce glare, eliminate blind spots and block the ultra violet light of the sun, the Driver's Blind Spot Terminator is easily attached to any existing sun visor, as well as a side door or dashboard. Easily accessed, the Driver's Blind Spot Terminator eliminates the blinding glare caused by overhead sunlight from both the windshield and side window. In this manner, use of the Driver's Blind Spot Terminator ensures that the driver safely sees the road ahead, as well as oncoming traffic approaching from the side, even on the sunniest of afternoons. Blocking the sun's harmful ultraviolet rays, use of the Driver's Blind Spot Terminator protects the eyes from potentially dangerous overexposure to the sun. Additionally, because the interchangeable discs included in the Driver's Blind Spot Terminator effectively protect the eyes from glare and sunlight, use of this product greatly reduces the eye and body fatigue associated with heat and glare. Although designed with the general consumer in mind, the Driver's Blind Spot Terminator proves an invaluable accessory for those who drive professionally. Easily installed, the Driver's Blind Spot Terminator is quickly employed when needed. City bus drivers, cabbies, truckers and delivery personnel all appreciate the many benefits this useful product affords. Durable, the Driver's Blind Spot Terminator withstands years of repeated use.

Reducing glare and blocking ultraviolet rays, the Driver's Blind Spot Terminator is a practical product invention which offers consumers a safe and comfortable means of driving in the sun. Simple to install, this unique product proves a valuable accessory for anyone who operates a motor vehicle.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. Adjustable automotive sun shield, comprising: a three piece sun shield is comprised of three, interchangeable and fully adjustable sun shields which are secured to the vehicle sun visor by way of a flexible support arm, wherein each sun shield is a geometrically shaped unit manufactured of optical glass or comparable shatterproof transparent material, wherein:
the first shield comprises a clear, polarized lens designed to filter the sun's harmful ultra violet rays;
the second shield is tinted a color to provide shady comfort while also blocking the sun's rays, wherein the color is selected from the group consisting of blue, gray and green;
the third shield is an amber colored shield designed for use during foggy or snowy conditions.

2. The sun shield of claim 1 further comprising a flexible support arm for securing the shield to the vehicle by way of a flexible support arm.

3. The sun shield of claim 2 wherein the flexible support arm is for mounting the shield to a sun visor, dashboard, or door handle.

4. The sun shield of claim 2 wherein the flexible support arm is an accordion arm.

5. The sun shield of claim 2 wherein the flexible support arm is a coiled support arm and measures approximately eighteen to twenty-four inches in total length, further having a sturdy, spring loaded clamp for use in securing the unit to the vehicle at its distal end, and further having a threaded female fitting utilized in conjunction with a corresponding male fitting secured to each shield at its proximal end.

6. The sun shield of claim 1 wherein the geometrically shaped units include, but are not limited to: circles, rectangles, ovals, pie shapes, triangles, wedges, or any other shapes.

7. The sun shield of claim 1, wherein the geometrically shaped units are disc-like and measure approximately six inches to twelve inches in diameter and feature a sturdy outer ring manufactured of lightweight metal or plastic material, providing structural support to the unit.

8. The sun shield of claim 1 further comprising a lightweight zippered carrying case.
